(19) United States
(12) Patent Application Publication
(10) Pub. No.: US 2020/0241488 A1
(43) Pub. Date: Jul. 30, 2020

(54) Controller Optimization for a Control System of a Technical Plant

(71) Applicant: Siemens Aktiengesellschaft, Muenchen (DE)

(72) Inventors: Benjamin Lutz, Pfinztal (DE); Gerrit Wolf, Karlsruhe (DE)

(21) Appl. No.: 16/748,198

(22) Filed: Jan. 21, 2020

(30) Foreign Application Priority Data
Jan. 24, 2019 (EP) 19153564

(51) Int. Cl. G05B 13/04; G05B 21/02

(52) U.S. Cl. CPC G05B 13/041; G05B 13/047; G05B 21/02

(57) ABSTRACT

A method for generating closed-loop control parameters of a closed-loop control for a control system of a technical system includes continuous determination of trend data of the closed-loop control during runtime of the technical system by means of the control system, continuous checking of the trend data to determine whether at least one specific trigger criterion has been met, transmitting the trend data of the closed-loop control to a controller optimization module in the event the specific trigger criterion is met, generating revised closed-loop control parameters by the controller optimization module, and transmitting the closed-loop control parameters generated by the controller optimization module to the control system.

### BACKGROUND OF THE INVENTION

### 1. Field of the Invention

The invention relates to a method for generating closed-loop control parameters of a controller of a control system of a technical system, an operator station client of an operator station server of a control system of the technical system, a control system for the technical system and use of the control system to operate the technical system.

### 2. Description of the Related Art

Control loops are the smallest technological unit in the automation of process engineering production plants. Control loops form the basis of all types of process control because they assure the fulfillment of the specified setpoints with respect to parameters, such as level, flow rate, temperature and/or pressure and, hence, facilitate the operation of a plant from a process engineering point of view. It is, therefore, important for plant operators to attempt to ensure that their control loops are kept properly adjusted to avoid excessive process fluctuations (losses of quality), energy and material losses due to poor response times or overstressing of the actuators (e.g. pumps, or valves) caused by vibrations or a high degree of variability at the actuator (controller output).

However, the hardware (actuator, controlled system and sensor) must be correctly dimensioned and the parameterization of the controller in the automation program must be coordinated therewith (tuning) to enable efficient control loop operation. However, in practice, such tuning is very costly in terms of time and resources. As a rule, on commissioning, plants are initially put into operation with standard parameter sets. These are generally selected based on experience for the respective systems (depending upon pressure, flow rate, or level) and are set in the software.

Evaluations show that even after many years of operation of a production-engineering plant, many control loops are still running in such an initial standard configuration. At present, tuning is only performed when there are problems with operation or potential for improvement is suspected.

For this application, there are a wide variety of tools for controller optimization. One example of this is the software tool “PID Tuner” made by the company Siemens which, as with conventional controller optimization, is used in tests on the process engineering plant. To this end, a jump is initiated on the open system (actuator, process, sensor) in the engineering system where all the necessary parameters of the controller blocks are located and the response is recorded. In such a case, the actual production is stopped because the experiments are carried out without disruption (for example, maintenance window). The software tool then determines new parameters that can be accepted and have to be put into operation by the user. However, the software tool cannot be applied to all types of PID blocks as a result of which there is a low degree of integration in the actual control system. Therefore, at present, controller optimization is a tedious process that tends to be performed in the form of a project.

Such experiments often cannot even be implemented at all with many processes, such as, thermal melting, and also with many chemical reactions because there is either a risk of rendering apparatus unusable or it is simply not possible to simulate reality in experiments.

A further known possibility of controller optimization is to resort to historical data. Such data is obtained in normal operation and automatically examined for jumps, which are then calculated on the control loop (controller, actuator, system, sensor). This method supports several different types of PID blocks. However, for this, the data must first be collected from the control system and transferred to a process data archive. The results are then analyzed by experts and reintroduced into the system. A problem here is that no analysis can occur if the process has not exhibited any dynamics during this time, (jumps or changes to the setpoint). Moreover, this method of analysis does not provide any information on the other components of the control system, which makes it difficult to draw conclusions regarding the operating state—in which the underlying process data for the optimization was obtained. In addition, the possibility of human error cannot be excluded when the parameters are returned to the plant.

Due to physical changes, controller optimization is not a one-off process but must be performed regularly in order, for example, to offset the effects of deposits, ageing etc. The conventional methods known to date cannot do this.

### SUMMARY OF THE INVENTION

In view of the foregoing, it is an object of the invention to provide a method for generating closed-loop control parameters of a controller for a technical system that is sensitive to context, but non-invasive with respect to the ongoing operation of the technical system.

This and other objects and advantages are achieved in accordance with the invention by a method for generating closed-loop control parameters of a controller of a control system of a technical system, by an operator station client of an operator station server of the control system of the technical system, by a control system for the technical system, and by a use of the control system to operate the technical system.

In accordance with the invention, the method for generating closed-loop control parameters of the controller of the control system of a technical system comprises a) continuous determination of trend data of the closed-loop control during runtime of the technical system by means of the control system; b) continuous checking of the trend data to determine whether at least one specific trigger criterion has been met; c) transmitting the trend data of the control to a controller optimization module in the event of the specific trigger criterion being met; d) generating revised closed-loop control parameters by the controller optimization module; and e) transmitting the closed-loop control parameters generated by the controller optimization module to the control system.

In the present context, a control system should be understood to mean a computerized technical system comprising functionalities for displaying, operating and controlling a technical system, such as a manufacturing or production plant. In accordance with the invention, the control system comprises sensors for determining measured values and various actuators. The control system moreover comprises so-called process- or manufacturing-related components, which are used to actuate the actuators or sensors. In addition, the control system inter alia comprises means for visualizing the technical plant and for engineering. The term control system additionally also includes further computing units for more complex closed-loop controls and systems for data storage and processing.

In accordance with the invention, a technical system should be understood to means a plurality of machines, devices or applications, which are in a functional and often also spatial relationship to one another. The technical system can, for example, be produced or manufactured with (large-scale) technical dimensions, products or components. However, the technical system can, for example, also be an automobile, a ship or an aircraft.

The term “closed-loop control” should be understood to mean a process with which process variables to be controlled, such as temperature, pressure, flowrate or level, are continuously compared with another variable, the “manipulated variable” and the value of the process variables is influenced in dependence on a result of this comparison. As a rule, the closed-loop control has various predefinable closed-loop control parameters, such as controller gain, reset time or derivative time.

The term “trend data” should be understood to mean data that is characteristic of the closed-loop control of the technical system. This can, for example, be a time profile of the process variable to be controlled and the corresponding manipulated variable.

During the checking of the trend data (method step b), a specific time segment of the trend data is monitored and evaluated. In the event of a specific prespecified trigger criterion being met, the trend data forwarded to the controller optimization module is that currently located within the specific time segment.

The controller optimization module uses closed-loop control optimization methods that are known per se and generates closed-loop control parameters that are in turn transferred to the closed-loop control in the control system. There, the closed-loop control can then occur with the revised (or newly generated) closed-loop control parameters. Before forwarding to the controller optimization module, the trend data of the closed-loop control is subjected to normalization or standardization thus enabling the use of any controller optimization modules from various manufacturers.

The method in accordance with the invention enables optimization of the closed-loop control in parallel to operation that is sensitive to the operating status during runtime of the technical system. The current statuses of the technical system can be taken into account directly for the optimization, which can reduce the effort required for the optimization and increase its quality. An operator of the control system can manually accept the closed-loop control parameters generated for the existing closed-loop control. However, it is alternatively also possible for the closed-loop control parameters generated to be automatically accepted for the closed-loop control.

A “trigger criterion” can be an overshooting and/or undershooting of at least one threshold value in the trend data. Alternatively or additionally, a trigger criterion can be a quantitative overshooting of a rate of change in the trend data. Moreover, a user input of an operator operating the control system is possible as a trigger criterion. The trigger criteria can be implemented separately. However, it is also conceivable for a plurality of trigger criteria to be implemented in parallel so that the trend data is transmitted in different scenarios to the controller optimization module.

In an advantageous embodiment of the invention, the closed-loop control of the control system and the controller optimization module are implemented on mutually independent separate computer infrastructures. This means, for example, that the closed-loop control of the control system is implemented on a first server (for example, operator station server) and the controller optimization module is implemented on a second server. As a result, the controller optimization can run/execute on the second server without any negative side effects for the first server.

In principle, the above-described method can be activated repeatedly at any desired times. Herein, the closed-loop control parameters generated are independent of one another and can be accepted or rejected for the closed-loop control as required. The closed-loop control parameters generated can be stored in a data archive of the control system to enable it to be evaluated in further course, in particular in the context of an audit trail.

It is also an object of the invention to provide an operator station client of an operator station server of a control system of a technical system. The operator station client is configured to a) determine trend data of a closed-loop control of the control system continuously during runtime of the technical system, to retrieve it from the operator station server and display it on a display device of the operator station client in a first application environment; b) check the retrieved trend data as to whether at least one specific trigger criterion has been met; c) transfer in the event of the at least one specific trigger criterion being met a subset of the trend data into a second application environment that is displayed on the display device and is independent of the first application environment; d) transfer starting from the second application environment the subset of the trend data to the second application environment to a controller optimization module; e) receive the closed-loop control parameters revised by the controller optimization module and display them in the second application environment; f) transfer the revised closed-loop control parameters from the second application environment to the first application environment; and g) transfer the revised closed-loop control parameters to the closed-loop control.

In accordance with the invention, an “operator station server” should be understood to mean a server that centrally acquires data from an operator control and monitoring system and, as a rule, also the alarm and measured value archives of a process control system of a technical plant and makes these available to users. As a rule, the operator station server establishes a communication connection to automation systems of the technical plant and forwards data of the technical plant to “clients”, which are used for operator control and monitoring of the operation of the individual functional elements of the technical plant. The operator station server can also feature client functions so that they can access data (archives, messages, tags, variables) on other operator station servers. This enables images of the operation of the technical plant on the operator station server to be combined with variables on other operator station servers (server-server communication). Without restriction thereto, the operator station server can be a SIMATIC PCS 7 Industrial Workstation server made by the company SIEMENS.

The transfer of the time range considered to be relevant (trigger criterion met) in the trend data initially occurs from a first application environment on the operator station client to a second application environment independent thereof. Here, it is then possible, independently of any communication with the operator station server, for the actual controller optimization to be activated during runtime of the technical system without any negative influence on the system. Before the transfer of the closed-loop control parameters generated from the second application environment to the first application environment (which is in direct exchange with the operator station server), a decision can be taken as to whether the closed-loop control parameters generated should be accepted for the closed-loop control.

The operator station client is preferably configured to retrieve trend data of a plurality of closed-loop controls and to further process this retrieved data as explained above.

The revised closed-loop control parameters received from the closed-loop control optimization module can, independently of any transfer to the first application environment, be stored in a data archive of the operator station server. The operator station client may possibly be formed for this purpose.

It is also an object of the invention to provide a control system for a technical system, in particular a manufacturing or process plant, which is embodied and provided to carry out a method as explained above.

It is also a further object of the invention to use such a control system to operate a technical system, in particular a manufacturing or process plant.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention and the manner in which these are achieved will become clearer and more plainly comprehensible in conjunction with the following description of the exemplary embodiment, which is explained in more detail in conjunction with the drawings, in which:

FIG. 1 is an illustration of a part of a control system of a technical system formed embodied as a process-engineering plant in accordance with the invention; and

FIG. 2 is a flowchart of the method in accordance with the invention.

### DETAILED DESCRIPTION OF THE EXEMPLARY EMBODIMENTS

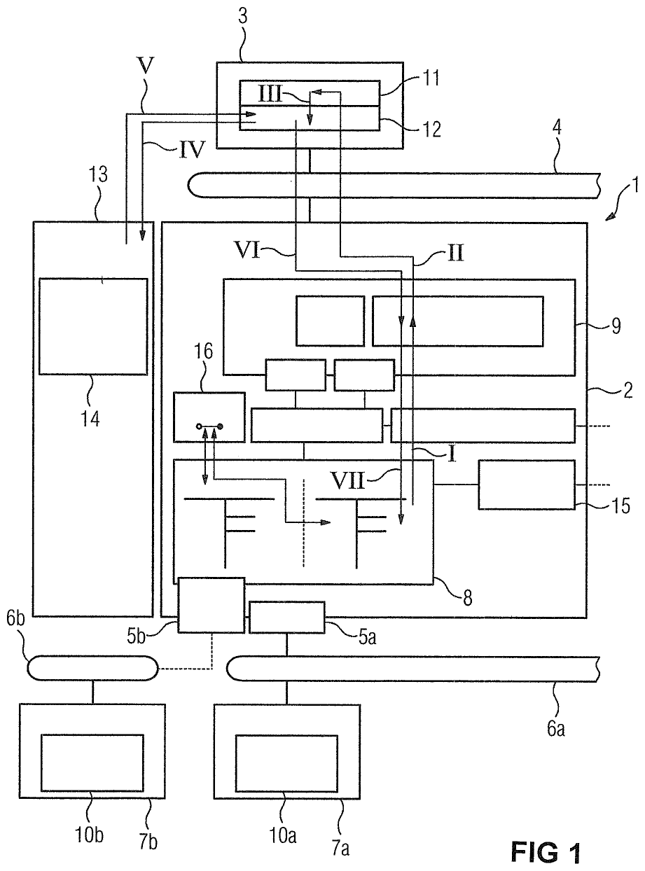

FIG. 1 shows a part of a control system 1 in accordance with the invention of a technical system formed as a process-engineering plant. With additional reference to FIG. 1, the control system 1 comprises a server of an operator control system or an operator station server 2 and an associated operator station client 3. The operator station server 2 and the operator station client 3 are connected to one another via a terminal bus 4 and with further components of the control system 1 that are not depicted, such as an engineering system server.

In the context of operator control and monitoring, a user or operator can access the operator station server 2 via the operator station client 3 over the terminal bus 4. Without restriction thereto, the terminal bus 4 can, for example, be formed as an industrial Ethernet.

The operator station server 2 has device interfaces 5a, 5b, which are each connected to a plant bus 6a, 6b. The operator station server 2 can communicate with devices via these interfaces 7a, 7b (here an automation station). A closed-loop control 10a, 10b is implemented in each of the two devices 7a, 7b.

Herein, the connected devices 7a, 7b can alternatively also be an application, in particular a Web application. In the context of the invention, any number of devices 7a, 7b and/or applications can be connected to the operator station server 2. Without restriction thereto, the plant buses 6a, 6b can, for example, be formed as an industrial Ethernet. The devices 7a, 7b can in turn be connected to any number of subsystems (not depicted).

The operator station server 2 has a process image 8 in which process data of the process-engineering plant, such as the data of the two closed-loop controls 10a, 10b, are stored. In addition, a visualization service 9, via which (visualization) data can be transferred to the operator station client 3, is integrated in the operator station server 2.

A trend display service 10 which, on the request of an operator of the control system 1, retrieves trend data of one of the two closed-loop controls 10a, 10b of the control system 1, such as the manipulated variable and process variable to be controlled, from the process image 8 (step I), and transfers it to the operator station client 3 (step II), is implemented within the visualization service 9. Within the operator station client 3, the trend data is depicted in a first application environment 11.

The retrieved test data is checked to determine whether at least one trigger criterion is met, for example, the overshooting or undershooting of a threshold value or a specific rise or fall in the trend data. Such events can then be used on an automated basis as the basis for the forwarding of a current time range of the trend data to a second application environment 12 (step III). However, the trigger criterion can also be a manual evaluation and a corresponding input on the part of the operator, who can evaluate trend data correctly based on experience.

Starting from the second application environment 12, the trend data is then transferred to a separate server 13 independent of the operator station server 2 (step IV). This server 13 can be located within or outside the process-engineering plant (cloud-based). Herein, a cloud should be understood to be a computer network with online-based storage and server services, which are usually referred to as the cloud or cloud platform. The data stored in the cloud data can be accessed online so that the process-engineering plant also has access to a central data archive in the cloud via the internet.

The server 13 comprises a controller optimization module 14, which uses the received trend data to generate optimized closed-loop control parameters for one of the two closed-loop controls 10a, 10b and transfers them back to the second application environment 12 (step V). Here, the operator can decide whether to transfer the new closed-loop control parameters to the relevant closed-loop control (steps VI, VII) or reject it as unusable. However, it is alternatively also possible for the revised closed-loop control parameters to be used automatically (without operator intervention) for one of the two closed-loop controls 10a, 10b.

Independently of the operator's decision, the closed-loop control parameters generated are stored in a data archive 15 of the operator station server 2. In principle, an operator can initiate a plurality of controller optimizations at different times and with different plant statuses without the closed-loop control parameters generated having to be accepted immediately. Instead, the results are recorded in the data archives 15 so that they can be evaluated at a later time by a project engineer responsible for the process-engineering plant.

Also implemented on the operator station server 2 of the control system 1 is a standardization module 16, which converts the trend data received from the individual (possibly different) closed-loop controls 10a, 10b in the process image 8 into uniform data structure so that any controller optimization module 13 (that is suitable per se) made by any manufacture can be used to generate the closed-loop control parameters.

Although the invention has been illustrated and described in greater detail by the preferred exemplary embodiment, the invention is not restricted by the disclosed examples and other variations can be derived herefrom by the person skilled in the art without departing from the scope of protection of the invention.

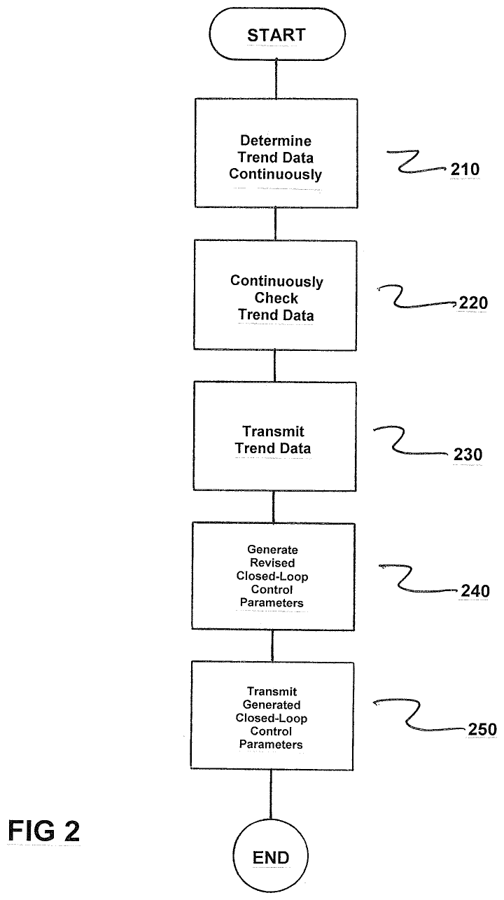

FIG. 2 is a flowchart of the method for generating closed-loop control parameters of a closed-loop control 10a, 10 for a control system 1 of a technical system. The method comprises determining trend data of the closed-loop control 10a, 10b continuously during runtime of the technical system via the control system 1, as indicated in step 210.

Next, the trend dated is continuously checked to determine whether at least one specific trigger criterion has been met, as indicated in step 220.

Next, the trend data of the closed-loop control 10a, 10b is transmitted to a controller optimization module 14 in an event the specific trigger criterion is met, as indicated in step 230.

Next, revised closed-loop control parameters are generated by the controller optimization module 14, as indicated in step 240.

Next, the closed-loop control parameters generated by the controller optimization module 14 are transmitted to the control system 1, as indicated in step 250.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for generating closed-loop control parameters of a closed-loop control for a control system of a technical system, the method comprising:
a) determining trend data of the closed-loop control continuously during runtime of the technical system via the control system;
b) checking the trend data continuously to determine whether at least one specific trigger criterion has been met;
c) transmitting the trend data of the closed-loop control to a controller optimization module in an event the specific trigger criterion is met;
d) generating revised closed-loop control parameters by the controller optimization module; and
e) transmitting the closed-loop control parameters generated by the controller optimization module to the control system.

2. The method as claimed in claim 1, wherein at least one trigger criterion comprises at least one of (i) an overshooting and (ii) undershooting of at least one threshold value in the trend data.

3. The method as claimed in claim 1, wherein at least one trigger criterion comprises a quantitative overshooting of a rate of change in the trend data.

4. The method as claimed in claim 2, wherein at least one trigger criterion comprises a quantitative overshooting of a rate of change in the trend data.

5. The method as claimed in claim 1, wherein at least one trigger criterion comprises a user input by an operator operating the control system.

6. The method as claimed in claim 1, wherein the closed-loop control of the control system and the controller optimization module are implemented on mutually independent separate computer infrastructures.

7. An operator station client of an operator station server of a control system of a technical system, the operator station client being configured to:
a) determine trend data of a closed-loop control of the control system continuously during runtime of the technical system, to retrieve said trend data from the operator station server and display said trend data on a display device of the operator station client in a first application environment;
b) check the retrieved trend data to determine whether at least one specific trigger criterion has been met;
c) transfer a subset of the trend data into a second application environment which is displayed on the display device and which is independent of the first application environment in an event the at least one specific trigger criterion is met;
d) transfer, starting from the second application environment, the subset of the trend data transferred to the second application environment to a controller optimization module;
e) receive closed-loop control parameters revised by the controller optimization module and to display said revised closed-loop control parameters in the second application environment;
f) transfer the revised closed-loop control parameters from the second application environment to the first application environment; and
g) transfer the revised closed-loop control parameters to the closed-loop control.

8. The operator station client as claimed in claim 7, wherein the operator station client is further configured to:
retrieve trend data of a plurality of closed-loop controls and further process said retrieved trend data of a plurality of closed-loop controls.

9. The operator station client as claimed in claim 7, wherein the operator station client stores the revised closed-loop control parameters received from the controller optimization module in a data archive of the operator station server.

10. The operator station client as claimed in claim 8, wherein the operator station client stores the revised closed-loop control parameters received from the controller optimization module in a data archive of the operator station server.

11. The operator station client as claimed in claim 7, wherein at least one trigger criterion comprises at least one of an (i) overshooting and (ii) undershooting of at least one threshold value in the trend data.

12. The operator station client as claimed in claim 8, wherein at least one trigger criterion comprises at least one of an (i) overshooting and (ii) undershooting of at least one threshold value in the trend data.

13. The operator station client as claimed in claim 9, wherein at least one trigger criterion comprises at least one of an (i) overshooting and (ii) undershooting of at least one threshold value in the trend data.

14. The operator station client as claimed in claim 7, wherein at least one trigger criterion comprises a quantitative overshooting of a rate of change in the trend data.

15. The operator station client as claimed in claim 7, wherein at least one trigger criterion comprises a user input by an operator operating the control system.

16. The operator station client as claimed in claim 7, wherein the closed-loop control of the control system and the controller optimization module are implemented on mutually independent separate computer infrastructures.

17. A control system for a technical system, the control system being configured to implement the method as claimed in claim 1.

18. The control system as claimed in claim 17, wherein the technical system comprises a manufacturing or process plant.

19. The control system as claimed in claim 17, wherein the control system operates a technical system.

20. The control system as claimed in claim 19, wherein the technical system comprises a manufacturing or process plant.
